(19) United States
(12) Patent Application Publication
(10) Pub. No.: US 2006/0194086 A1
(43) Pub. Date: Aug. 31, 2006

(54) Inverse recycle power system

(76) Inventor: Kuai-Teng Hsu, Clarksville, MD (US)

Correspondence Address: Raymond Y. Chan, #128, 108 N. Ynez Ave., Monterey Park, CA, 91754, US

(21) Appl. No.: 11/066,364

(22) Filed: Feb. 25, 2005

(51) Int. Cl. H01M 8/06

(52) U.S. Cl. 429/21; 429/17

(57) ABSTRACT

An inverse-recycle power system processes a dissociation of water into a hydrogen gas and an oxygen gas and a fusion of hydrogen gas and oxygen gas forming a recycled water while generating an electric current. The electric current is then used for powering any electrical devices, and more particularly, automobiles. The inverse-recycle power system can self-sustain, with an occasional need of water refill. At the end of the system, water is regenerated and recycled, and a portion of the electric current is used for powering the dissociation of water. The dissociation of water is carried out by an electrolysis process, which is enhanced by the addition of a dissociation catalyst that would be regenerated and recycled after assisting water to dissociate in to hydrogen gas and oxygen gas. The fusion of hydrogen gas and oxygen gas to generate the electric current is essentially carried out by a fuel cell system.

### BACKGROUND OF THE PRESENT INVENTION

1. Field of Invention

The present invention relates to a power system, and more particularly to an inverse-recycle power system which is a power source that utilizes water as the fuel, instead of flammable material such as gasoline or hydrogen gas, for devices such as machines and automobiles, so as to provide a saver, environmental and renewable source of energy.

2. Description of Related Arts

Most automobiles, such as cars, planes, boats, are powered by gasoline. Gasoline is converted into gas in a combustion engine to mix with air. The mixture is then compressed and combusted to push one or more pistons to rotate a crankshaft, thereby powering a vehicle or a machine. Over the years, people have relied heavily on such combustion engines due to its balance between cost and performance.

However, as time goes by, a lot of draw backs have been discovered for such combustion engines. The first one is that they utilize fossil fuels such as gasoline, which is a non-recyclable or non-renewable source of energy. It is now a global issue that other sources of energy have to be discovered since the abundance of fossil fuels is decreasing and will run out in the coming thirty or so years.

The second is that, greenhouse gases such as carbon monoxide, CO, and carbon dioxide, CO₂, are produced during the combustion of fossil fuels. It contributes to the global epidemic of greenhouse effect and global warming.

The third drawback is that gasoline, even in high quality, usually contains a lot of impurities that cannot be eliminated. Such impurities either cause the emission of other harmful gases such as NOₓ and dioxin during combustion, or cannot be burnt, leaving behind residues in the combustion engine, which would affect the performance of the combustion engine.

In order to maintain high performances of vehicles or automobiles, as well as helping to preserve the environment, manufacturers have been working closely with energy experts in the past decade or two to develop new types of automobiles that would shift our reliance on gasoline.

Attempts had been put on the development of solar powered automobiles. However, they never became popular due to the fact that they are expensive, due to the cost of the solar panels, and non-reliable, due to the fact that they can run basically only when the sun shines.

Recent technology brought about the prototypes of hybrid automobiles and fuel cell automobiles. Hybrid automobiles are those that combine two sources of energy together. They, nowadays, combine energy released by the burning of gasoline and electrical energy. The powering components of hybrid automobiles are essentially a gasoline engine, a fuel tank, an electric motor, and batteries. The gasoline engine burns gasoline just like any conventional automobiles.

Unlike conventional automobiles, the energy generated by the burning of gasoline is not only being used to power the automobile or go wasted, it can be stored in the fuel tank. The electric motor acts as both a motor and a generator, draws energy from the batteries when the automobile accelerates, and stores energy in the batteries when the automobile decelerates. Hence, energy released by the burning of gasoline is more fully utilized, decreasing gasoline consumption and emission of harmful gases, thereby conserving the environment.

However, despite the decreased consumption of gasoline, hybrid automobiles, nevertheless, depends on gasoline as the main source of energy, i.e. converting energy released by the burning of gasoline to generate electrical energy for storage and power the automobile.

Fuel cell automobiles eliminate the reliance on gasoline. They utilize fuel cells to produce electrical energy by fusing hydrogen as with oxygen gas to form water. The fuel cell system is in fact an electric generator rather than battery. As can be seen, unlike conventional cars fuel cell automobiles, they do not require the consumption of gasoline. Automobiles powered by fuel cells which also have much higher energy efficiency. It has been proven that fuel cell automobiles are up to 80% efficient, which is much higher than the 20% energy efficiency of a gasoline car.

Unfortunately, in order for the automobiles to run, hydrogen has to be constantly supplied to the fuel cells. In other words, the fuel cell automobile must carry a huge tank of hydrogen. However, it is well known that hydrogen not only requires a large storage but also is a kind of dangerous gas that is difficult to store and distribute and is highly flammable and relatively low in abundance. Hence, the storage of hydrogen gas in an automobile is not feasible. In the hope of overcoming such drawbacks, scientist developed certain alternatives in the supply of hydrogen.

By the utilization of what is called a reformer, alternative sources of fuels can be turned into hydrogen which is then supplied to the fuel cells. The first type of alternative sources of fuel is hydrocarbon or alcohol fuels. Such fuels have the drawback of producing gases along with the hydrogen, which makes the hydrogen produced impure and lowers fuel cell efficiency. Another type is natural gases such as propane or methanol. Methanol is a good hydrogen gas provider since it is a liquid fuel that consumes less space and has similar properties to gasoline which makes it easy to transport and distribute. However with the use of methanol, the automobiles are still carrying around flammable fuels similar to that of gasoline.

Furthermore, the greatest drawback of the use of a reformer with the fuel cells is that it decreases the overall efficiency of the automobile to only about 24% to 32%, which looses the attraction of converting to the use of fuel cell automobiles.

As a result, in order to maintain the high energy efficiency of a fuel cell automobile, as well as to remove our reliance on fossil fuels, limiting and even eliminating emissions of greenhouse or other harmful gases, thereby conserving our environment, a better supply of hydrogen gas for fuel cell power system is a long felt demand in the Earth.

### SUMMARY OF THE PRESENT INVENTION

A main object of the present invention is to provide an inverse-recycle power system which comprises a water dissociation device provided for dissociating water into hydrogen gas and oxygen gas as fuel supply for electric generator such as fuel cell for devices such as automobiles or machines.

Another object of the present invention is to provide an inverse-recycle power system and method thereof, wherein water is dissociated into hydrogen gas and oxygen gas which are then fused together. During the fusion, the hydrogen gas and oxygen gas are fused together to form water and dissipate a huge amount of energy. The water formed from the fusion is then recycled back to the starting point of the power system.

Another object of the present invention is to provide an inverse-recycle power system which provides a continuous supply of hydrogen gas and oxygen gas from a water dissociation device for an electric generator which is a fusion electricity generating device (such as a fuel cell) having a hydrogen gas inlet receiving the hydrogen gas from the hydrogen gas outlet of the water dissociation device and an oxygen gas inlet receiving the oxygen gas from the oxygen gas outlet of the water dissociation device, wherein the fusion electricity generating device fuses the hydrogen gas and the oxygen gas together to form a recycled water and generating an electrical current, wherein the recycled water is recycled to the water inlet.

Another object of the present invention is to provide an inverse-recycle power system and method thereof, wherein a portion of the electricity generated by the fusion electricity generating device is used to power the water dissociation device after the water dissociation has started.

Another object of the present invention is to provide an inverse-recycle power system where electricity is produced in a safe and environmentally friendly manner. Since water is basically the only raw material required to be refilled, no flammable or non-recyclable or non-renewable sources of energy are required for the production of electricity.

Another object of the present invention is to provide an inverse-recycle power system and method thereof, wherein a water dissociation initializing power source, such as a capacitor, is only used to initialize the water dissociation of the water dissociation device the water dissociation initializing power source is a capacitor, such that a portion of the power generated by the power system is stored in the capacitor so as to provide power for initializing the water dissociation process, such that no external power is required.

Another object of the present invention is to provide an inverse-recycle power system, wherein the raw material used by the system, water, is a clean substance that does not leave behind residuals, such that the elements of the system remain clean, posting a much lower maintenance cost on the system, which in turn would lower the overall electricity generating cost, thereby providing a cheaper source of electricity.

Another object of the present invention is to provide an inverse-recycle power system which can replace conventional combustion engines in cars and other electricity generation devices, such that a reliable, abundant, safe, easily accessible and environmentally friendly source of renewable energy where no extraction process is required can be provided, so as to alter our power consumption behavior and remove our reliance on non-renewable sources of energy such as fossil fuels.

Another object of the present invention is to provide an inverse-recycle power system and method thereof which would not produce harmful by-products to the environment. No pollution will be caused to the environment. Hence, no purging of gases or by-products required and thus energy loss due to purging of harmful by-products is minimized.

Another object of the inverse-recycle power system and method thereof of the present invention is to provide a reliable source of energy, wherein the system requires only a small power input by the water dissociation initializing power source to produce a relatively great amount of electricity, such that the energy efficiency of the system is maximized.

Another object of the inverse-recycle power system and process of the present invention is to maximize the hydrogen gas and oxygen gas production and the fusion of the H⁺ ions and oxygen atoms and minimize energy consumption in the water dissociation process by selectively employing dissociation catalysts to enhance the efficiency of the dissociating of water.

Another object of the inverse-recycle power system of the present invention is to provide portability to the power system, such that the power system is detachable and is capable of being applied onto more than one piece of machinery or automobile, wherein the system further comprises a housing for containing the water dissociation device and the fusion electricity generating device.

Another object of the present invention is to provide a method of powering an electric-driven automobile, wherein the only fuel that the automobiles have to carry around is water, such that the automobiles do not have to carry about flammable substances, causing potential fire and explosion hazard.

Another object of the present invention is to provide a method of powering an electric-driven automobile, wherein the availability and cost of fuels are no longer a concern since water, which is low in cost and highly abundant, is the only fuel required by the automobile.

Another object of the present invention is to provide a method of powering an electric-driven automobile, wherein the automobile posts considerably little, or even none fire or explosion hazard since at any given point in time, the presence of flammable substances within the automobile is minimal.

Another object of the present invention is to provide a method of powering an electric-driven automobile, wherein the automobile does not require frequent refilling of fuel due to the fact that the fuel, water, is regenerated after the electrical current is generated and recycled to the water dissociation device, and will only be lost through evaporation, as oppose to fossil fuel consumption in conventional automobiles requiring constant refill.

Another object of the present invention is to provide a method of powering an electric-driven automobile, wherein the automobile has zero or minimal emission, providing means of transport that will not sacrifice the environment for human benefits.

Accordingly, in order to accomplish the above objects, the present invention provides an inverse-recycle power system, comprising:

a water dissociation device having a dissociation chamber defined therein for receiving a water, wherein the water dissociation device is adapted for dissociating the water into a hydrogen gas and an oxygen gas, wherein the water dissociation device comprises:

a water inlet,

a predetermined amount of dissociation catalyst for mixing with the water to form an electrolyte to increase a water dissociation rate,

a water dissociation initializing power source initializing the water dissociation,

a dissociation positive electrode and a dissociation negative electrode each having a power connection end electrically connecting to the water dissociation initializing power source,

a contacting portion contacting with the electrolyte so as to form a complete electrical circuit in the water dissociation device,

a hydrogen gas outlet collecting the hydrogen gas produced at the dissociation negative electrode, and

an oxygen gas outlet collecting the oxygen gas produced at the dissociation positive electrode; and

a fusion electricity generating device equipped with the water dissociation device for generating an electrical current through the fusion of the hydrogen gas and the oxygen gas forming a recycled water, wherein the fusion electricity generating device receives the hydrogen gas from the hydrogen gas outlet and the oxygen gas from the oxygen gas outlet of the water dissociation device.

The present invention also provides a method of generating power comprising the steps of:

(a) initiating a dissociation of water in a water dissociation device to produce a hydrogen gas and an oxygen gas;

(b) transmitting the hydrogen gas and oxygen gas produced from the water dissociation device to a fusion electricity generating device; and

(c) generating an electrical current by fusing the hydrogen gas with the oxygen gas forming a recycled water.

The method of generating power may further comprise the steps of:

(d) powering the water dissociation device by a portion of the electrical current generated; and

(e) recycling the recycled water to the water dissociation device as the water for dissociation.

The present invention has an alternative embodiment, wherein the present invention provides a method of powering an electric-driven automobile comprising the steps of:

(a) providing a water dissociation device and a fusion electricity generating device in the automobile;

(b) electrically connecting the fusion electricity generating device to the automobile;

(c) dissociating a water into a hydrogen gas and an oxygen gas by the water dissociation device; and

(d) generating an electrical current by fusing the hydrogen gas and the oxygen gas dissociated-.by the water dissociation device forming a recycled water by the fusion electricity generating device, such that the electrical current is used to run the automobile.

Furthermore, according to the above method of powering an electric-driven automobile, the recycled water is recycled to the water dissociation device.

These and other objectives, features, and advantages of the present invention will become apparent from the following detailed description, the accompanying drawings, and the appended claims.

### BRIEF DESCRIPTION OF THE DRAWINGS

FIG. 1 is schematic view illustrating the inverse-recycle power system according to the preferred embodiment of the present invention.

FIG. 2A is a flow chart illustrating the steps of generating power according to the preferred embodiment of the present invention.

FIG. 2B is a flow chart illustrating the cycle of generating power according to the above preferred embodiment of the present invention.

FIG. 3 is a flow chart illustrating the method of powering an electric-driven automobile according to an alternative embodiment of the present invention.

FIG. 4 is a schematic diagram illustrating a solid electrolyte type water dissociation device according to the above preferred embodiment of the present invention.

FIG. 5 is a schematic diagram illustrating the solid electrolyte mechanism of a fuel cell according to the above preferred embodiment of the present invention.

FIG. 6 is a schematic diagram illustrating the mechanism of a double inverse recycle power system according to the above preferred embodiment of the present invention.

### DETAILED DESCRIPTION OF THE PREFERRED EMBODIMENT

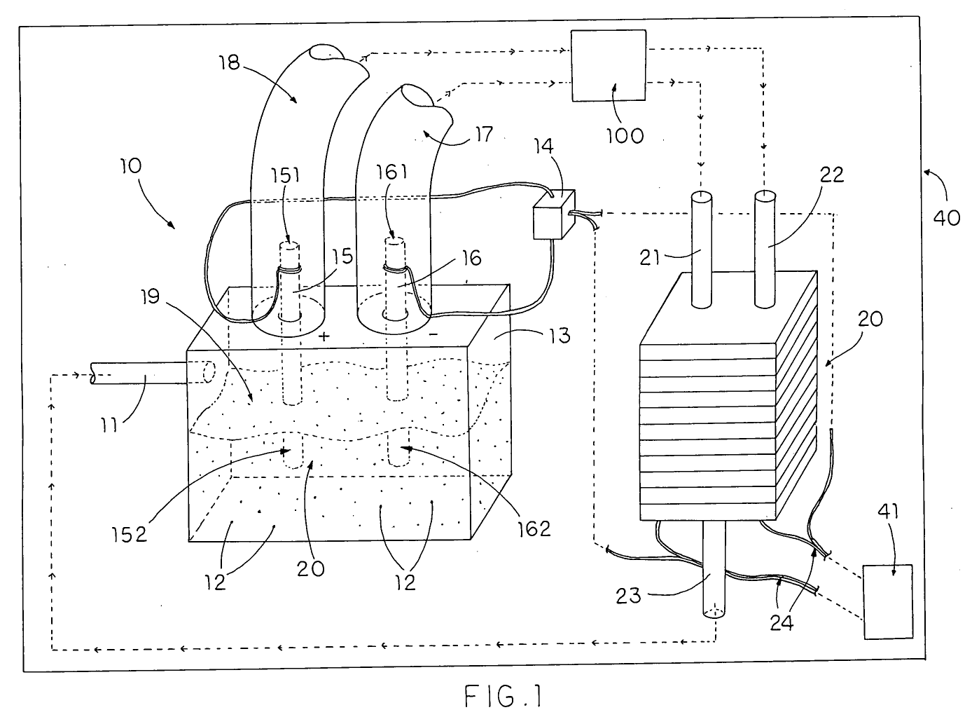

Referring to FIGS. 1-6 of the drawings, an inverse-recycle power system according to a preferred embodiment of the present invention is illustrated, wherein the power system comprises a water dissociation device 10 and a fusion electricity generating device 20.

The water dissociation device 10 comprises a water inlet 11 inputting water 12 into a dissociation chamber 13 defined in the water dissociation device 10, a water dissociation initializing power source 14 initializing the water dissociation, a dissociation positive electrode 15 and a dissociation negative electrode 16 each having a power connection end 151, 161 electrically connecting to the water dissociation initializing power source 14, and a contacting portion 152, 162 dipping into the water 13 received in the dissociation chamber 13 respectively for contacting reaction with the water 12.

According to the preferred embodiment of the present invention, in order to enhance the efficiency of the dissociating of the water 12, a predetermined amount of dissociation catalyst 121 is provided in the dissociation chamber 13 to form an electrolyte 122 with the water, wherein the dipping portions 152, 162 of the dissociation positive and negative electrodes 15, 16 are dipped into the electrolyte 122.

A complete electrical circuit is formed when the water dissociation initializing power source 14 is connected to the dissociation positive electrode 15 and the dissociation negative electrode 16 respectively while the electrodes 15 and 16 are dipped into the electrolyte 122. When the complete electrical circuit is formed, a hydrogen gas is produced at the dissociation negative electrode 15 and an oxygen gas is produced at the dissociation positive electrode 16.

Theoretically, even without the presence of the dissociation catalyst 121, upon the completion of the electrical circuit, water molecules, H₂O, will undergo an electrolysis process, where the H₂O molecules dissociates to H⁺ ions and OH⁻ ions. Since the H⁺ ions are now positively charged, meaning that each H⁺ ion is short of one electron, they are not physically stable. As a result, they are attracted to the negative electrode 16, where electrons are provided for them to discharge and neutralize, returning to a stable state. When H⁺ ions are discharged, the hydrogen gas is formed.

Analogously, since the OH⁻ ions are now negatively charged, meaning that each OH⁻ ion has one electron in excess, they are not physically stable. As a result, they are attracted to the positive electrode 15, where the electrons are taken away, such that the OH⁻ ions are discharged and neutralized, returning to a stable state. When the OH⁻ ions are discharged, the oxygen gas and water is formed.

Dissociation of H₂O molecules is represented by the following chemical equation:
H₂O₍₁₎⇄H⁺_{(aq)}+OH⁻_{(aq)}

The discharge and neutralization of H⁺ ions are represented by the following chemical equation:
2H⁺_{(aq)}+e⁻→H_{2 (g)}

The discharge and neutralization of OH⁻ ions are represented by the following chemical equation:
4OH⁻_{(aq)}+4e⁻→2H₂O₍₁₎+O_{2 (g)}

However, due to the fact that water molecule is a covalent compound hence the dissociation of water molecule being slow, the production of hydrogen gas and oxygen gas is slow, rendering the process not energy efficient.

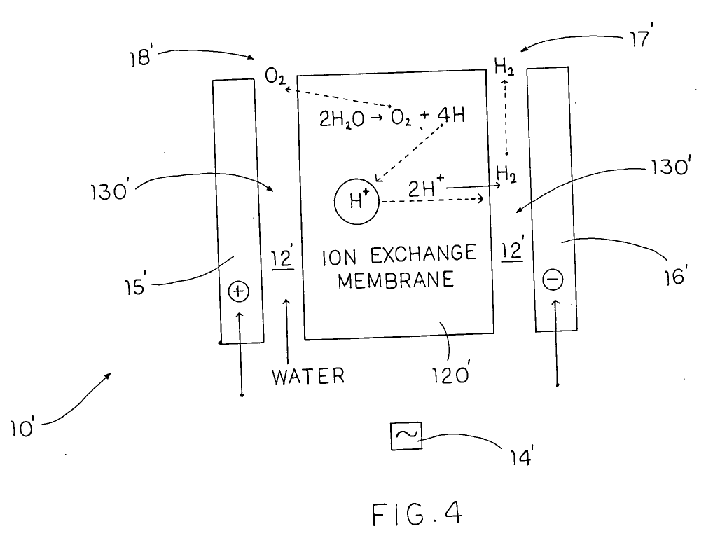

The water dissociation device 10 can be a solid electrolyte type water dissociation device 10′, as shown in FIG. 4, according to the preferred embodiment of the present invention, wherein an ion exchange membrane 120′ is disposed between the dissociation positive electrode 15′ and the dissociation negative electrode 16′ which are both made of nickel plates. The H₂O molecules of water 12′ passing through the gaps 130′ formed between the electrodes 15′, 16′ and the ion exchange membrane 120′ are contacting with the electrodes 15′, 16′.

When the electrodes 15′, 16′ are connected to the initializing power source 14′, electrical current flows through the ion exchange membrane 120′, driving the H⁺ ions to the dissociation negative electrode 16′ and the OH⁻ ions to the dissociation positive electrode 15′. The H⁺ ions receive electrons from the dissociation negative electrode 16′, such that H₂ hydrogen gas is released at the dissociation negative electrode 16′. The OH⁻ ions releases electrons to the dissociation positive electrode 15′, such that O₂ oxygen gas is released at the dissociation positive electrode 15′.

In order to enhance the production of hydrogen gas and oxygen gas from water, so as to make use of the abundant, environmental friendly substance as an energy source, the dissociation catalyst 121 is preferred to be added to the water 12 in the dissociation chamber 13 as shown in FIG. 1 or the water 12′ passing through the gaps 130′ between the dissociation positive and negative electrodes 15′, 16′ and the ion exchange membrane 120′.

According to the preferred embodiment of the present invention, the dissociation catalyst 121 comprises iodine (I₂) and sulfur dioxide (SO₂). I₂ and SO₂ will aid the dissociation of water molecules by first reacting with the water molecules to form hydrogen iodide (HI) and hydrogen sulfate (H₂SO_{4 (aq)}). The overall chemical equation of this reaction is as follows:
2I_{2 (g)}+2SO_{2 (g)}+4H₂O₍₁₎→4HI_{(aq)}+2H₂SO_{4 (aq)}

Then, the hydrogen sulfate dissociates to a regenerated water, sulfur dioxide and oxygen gas is produced at the dissociation positive electrode 15, 15′. The overall chemical equation of this reaction is as follows:
2H₂SO_{4 (aq)}→2H₂O_{(g)}+2SO_{2 (g)}+O_{2 (g)}

The hydrogen iodide will then dissociate into iodine and hydrogen gas is generated at the dissociation negative electrode 16, 16′. The overall chemical equation of this reaction is as follows:
4HI→2I_{2 (g)}+2H_{2 (g)}

The ratio between the water for dissociation, the iodine and the sulfur dioxide may vary, but is best to be 2:1:1 by mole.

According to this preferred embodiment of the present invention, an electrical circuit with a voltage of 25V and a current of 4 A is sufficient to start up the entire process, such that energy consumption is minimized and energy efficiency of the entire system maximized.

Since the iodine and sulfur dioxide are only for aiding the dissociation of water molecules and will be regenerated upon the completion of the dissociation of water to form the hydrogen gas and the oxygen gas, the iodine and the sulfur dioxide are recycled and added into the water 12, 12′. The generated water is also recycled to be used as the water 12, 12′ again for dissociation.

The water dissociation device 10, 10′ has a hydrogen gas outlet 17, 17′ for collecting the hydrogen gas produced at the dissociation negative electrode 15, 15′ and an oxygen gas outlet 18, 18′ for collecting the oxygen gas generated at the dissociation positive electrode 16, 16′.

The fusion electricity generating device 20, referring to FIG. 1, has a hydrogen gas inlet 21 receiving the hydrogen gas from the hydrogen gas outlet 17, 17′ of the water dissociation device 10, 10′ and an oxygen gas inlet 22 receiving the oxygen gas from the oxygen gas outlet 18, 18′ of the water dissociation device 10, 10.

The electric generator 20 is essentially one that would process the hydrogen gas and the oxygen as inputted to the electric generator 20 in such a manner that an electrical current is generated while the hydrogen gas and the oxygen gas are being fused to form a recycled water. The electrical current can then power an electrical device and more specifically, an automobile, by electrically connecting the electrical device to the electric generator 20 through electrical wires 24.

According to the preferred embodiment of the present invention, the water dissociation initializing power source 14, 14′ is embodied as a capacitor (or battery) that can be discharged and recharged thereby providing electricity to the water dissociation device 10, 10′ when electrical power is required, and storing energy when electrical power is provided respectively. When the capacitor is electrically connected to the electric generator 20 and while current is flowing in the electrical wires 24, a portion of the power is stored up into the capacitor, so as to power the water dissociation in the water dissociation device 10, 10′.

As an example, the capacitor acting as the water dissociation power source 14, 14′ is a lead-acid accumulator, wherein the lead-acid accumulator provides energy for the initialization of the water dissociation process. Once the water dissociation process has been initialized, the power system no longer relies on the power provided by the lead-acid accumulator.

While the lead-acid accumulator provides electrical energy for the initialization of the water dissociation process, when electricity consumption is low, such as during deceleration or breaking of a vehicle, excess electrical energy is stored into the lead-acid accumulator.

The chemical equation of the lead-acid accumulator providing or storing electrical energy is as follows:
PbO₂+Pb+2H₂SO₄⇄2PbSO₄+2H₂O

As the above reaction is not an instantaneous one, the equilibrium of the above reaction shifts to either side, depending on the condition surrounding the lead-acid accumulator. When the lead-acid accumulator is acting as a capacitor, i.e. electrical energy is being stored in the lead-acid accumulator, the reaction equilibrium shifts to the left hand side. Whereas when the lead-acid accumulator is acting as a battery cell, i.e. electrical energy is being provided by the lead-acid accumulator, the reaction equilibrium shifts to the right hand side.

The fusion electricity generating device is in fact an electric generator 20 that generally has a positive electrode, a positive electrode catalyst in contact with the positive electrode, a negative electrode, a negative electrode catalyst in contact with the negative electrode.

The hydrogen gas enters the electric generator 20 on the negative electrode through the hydrogen gas inlet 21, wherein the hydrogen gas is forced through the negative electrode catalyst by pressure. When the hydrogen gas is in contact with the catalyst, the hydrogen molecule splits into two H⁺ ions and releases two electrons. The chemical equation of the reaction at the negative electrode is:
2H₂=>4H⁺+4e⁻

The two electrons formed by each splitting of hydrogen molecules forms the electrical current which flows through the electrical wires 24, powering external devices, such as an automobile, and providing the power for the water dissociation device 10.

The oxygen gas enters the electric generator 20 on the positive electrode through the oxygen gas in let 22, wherein the oxygen gas is forced through the positive electrode catalyst, where the oxygen molecules are separated into two oxygen atoms. Due to the electronic configuration, the oxygen atoms are strongly negatively charged, attracting H⁺ ions are attracted towards the oxygen atoms, such that two H⁺ combine with an oxygen atom and two electrons from the electrical current of the electrical wires 24 to form a water molecule, forming the recycled water. The chemical equation of the reaction at the positive electrode is:
O₂+4H⁺+4e⁻=>2H₂O

Hence, the overall chemical equation of the reactions that take place in the electric generator 20 is:
2H₂+O₂=>2H₂O

In addition, control device 100 can be installed between the hydrogen and oxygen gas outlets 16, 16′, 17, 17′ of the water dissociation device 10, 10′ and the hydrogen and oxygen gas inlets 21, 22 of the fusion electricity generating device 20 for controlling the hydrogen gas and oxygen gas supply from the water dissociation device 10, 10′ to meet the requirement and consumption of the fusion electricity generating device 20.

The fusion electricity generating device, i.e. the electric generator 20, as described above can be a fuel cell stack system according to the preferred embodiment of the present invention. According to the preferred embodiment of the present invention, any type of fuel cells is possible to be incorporated into the inverse-recycle power system such that the present invention is easily adopted with present advance technology.

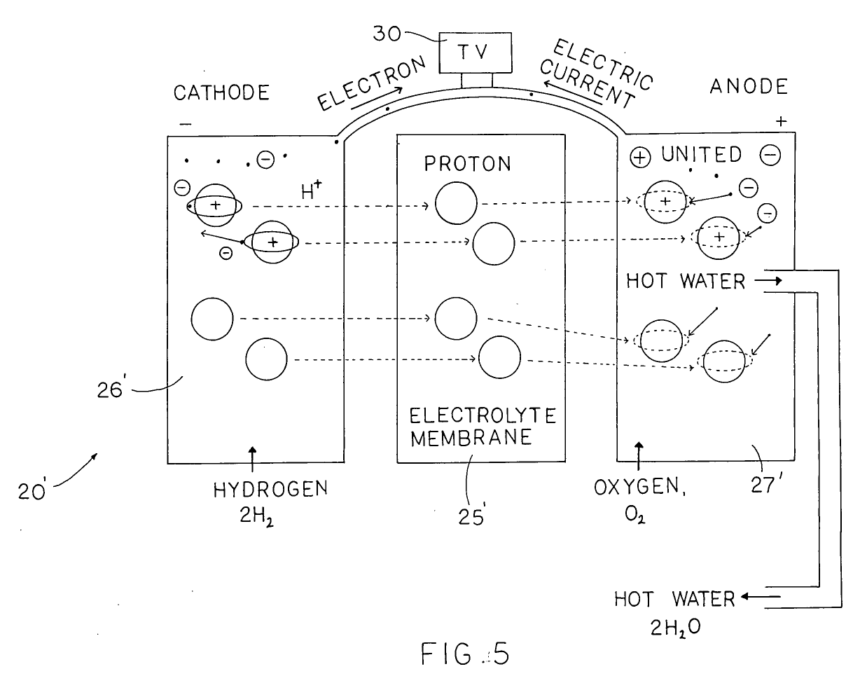

Types of fuel cells include: proton exchange membrane fuel cell, alkaline fuel cell, phosphoric-acid fuel cell, solid oxide fuel cell, molten carbonate fuel cell. Despite according to the preferred embodiment of the present invention, the proton exchange membrane fuel cell, as shown in FIG. 5, is preferable; however other types of fuels are possible to be incorporated into the power system.

As such fuel cells directly transform chemical energy to electrical energy efficiency can be as high as approximately 90%. As oppose to traditional fossil fuel generators, wherein fossil fuel such as coal is burnt to produce kinetic energy to push the turbines, along with heat and light energy, which will be lost, the energy efficiency is only about 30%.

According to the preferred embodiment of the present invention, the type of fuel cell system is embodied as a proton exchange membrane fuel cell, as shown in FIG. 5, wherein a proton exchange membrane (P.E.M.) 25′ is sandwiched between two pieces of porous nickel metal plate one acting as a cell positive electrode 26′ and one acting as a cell negative electrode 27′, wherein the fuel cell 20′ is connected to an electrical device 30, such as a car.

When hydrogen gas is inputted into the cell positive electrode 26′ and oxygen gas is inputted into the cell negative electrode 27′, the hydrogen gas releases electrons to the cell positive electrode 26′ and form H⁺ ions, which essentially are protons. The electrons operate the car then return to the cell positive electrode 26′.

As the H⁺ ions are essentially protons, they are small enough to pass through the proton exchange membrane 25′. Due to the difference in density of protons across the proton exchange membrane 25′, H⁺ ions in the cell positive electrode 26′ pass through the proton exchange membrane 25′ to the cell negative electrode 27′. The oxygen gas in the cell negative electrode 27′, together with the H⁺ ions and the electrons from the car 30, forms the recycled water. In order to increase the efficiency of proton exchange, the proton exchange membrane 25′ can be coated with platinum.

It is worth mentioning that the power produced by such a fuel cell system is proportional to the surface area and the number of layers of the proton exchange membrane 25′. The greater the surface area, and the greater the number of layers of the proton exchange membrane 25′, the power produced by the fuel cell system is higher.

In order to further increase the rate of the reaction in the fuel cell, a generation catalyst can be applied. According to the preferred embodiment of the present invention, an alkali liquor catalyst, soluble potassium hydroxide (KOH), is used, wherein the soluble KOH dissociates into:
2KOH→2K⁺+2OH⁻

And as the hydrogen gas dissociates into:
H₂→2H⁺+2e⁻

As a result, the chemical reaction in the cell negative electrode 27′:
2OH⁻+H_{2 (g)}→2H₂O+2e⁻

And the chemical reaction in the cell positive electrode 26′:

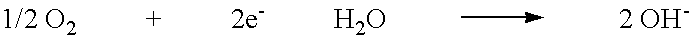

As can be seen, the OH⁻ dissociated from the soluble KOH and consumed by the cell negative electrode to produce water and two electrons are regenerated by the cell positive electrode 26′.

Due to the fact that at the electrolysis stage of the present invention ion exchange membrane is used together with SO₂ and I₂ as the dissociation catalysts, the rate of electrolysis is increased, and that at the power generation stage of the present invention proton exchange membrane 25′ is used together with KOH as the generation catalyst, the overall amount of power generated by this power system is greatly increased from conventional power generation methods.

The recycled water can either be recycled to the water inlet 11 of the water dissociation device 10, 10′ through a recycled water outlet 23, or used for other purposes within or outside the power system.

In order to provide portability to the power system, the power system further comprises a housing 40 adapted for accommodating the water dissociation device and the fusion electricity generating device, wherein the housing 40 has an electrical wire 41 defined thereon so as to allow the electrical wires 24 to connect with external devices.

The housing 40 allows the power system to be detachable from the external device, such that the power system can be removed from one external device and applied onto another.

Such portable power system also provides high convenience to automobiles owners. Engines are one of the most problem prone parts of a conventional automobile. And usually, if the engine fails, the entire automobile has to be left with the mechanics for fixing. The use of the automobile is totally jeopardized, causing great inconvenience to the owner. Imagine, even when such portable power system fails, all that has to be done is to take out the failed power system from the automobile for maintenance, and then replace by a functioning one. The automobile is then ready to go onto the road again. Performance and life-expectancy of automobiles will no longer be limited by the performance of the engine.

It is appreciated that, all raw materials, including water and catalysts, can self-regenerate. Hence, the power system does not require constant refilling of fuels, unlike conventional automobiles. The only material that may require occasional refilling is water.

Such a power system allows automobiles and other machineries to run on a fuel that is cheap, abundant and safe. Automobiles will no longer rely on expensive and inconvenient sources of energy such as fossil fuels, electricity or even hydrogen gas.

The reliance on flammable, dangerous, explosive and unclean fuels of human beings can be phased out by this new power system. Together with the fact that it does not involve any emission of gases, dangerous mining, extraction or purification processes, burning of fuels, and the use of radioactive substances, this power system provides a cleaner world to man kind.

It is worth mentioning that since this power system uses water as its fuel, where water is an inherently clean substance that will not produce residues in the system wearing out parts in the system, keeping maintenance cost of the system low, which in turn would benefit end users of the power generated by this power system by not having to pay as much for the same amount of energy.

Furthermore, human beings will no longer be threatened by the long standing energy shortage problem. Advances in technology will no longer be limited by relying on fuels that are either relative cheaper but low in abundance, or abundance but more expensive. This power system can effectively and economically be used to replace all power generators or power generating methods, especially those in chemical plants, machineries and automobiles.

It should also be pointed out that the entire power system does not require the burning of fuels or any storage gas flammable gas. Once the hydrogen or oxygen are generated by the water dissociation device, they will be used to generate the electrical current in the fusion electricity generating device and converted back into water, which is non-reaction and non-explosive. It can easily be imagined that vehicles become a lot safer, especially when they involve in collision accidents. Such power system incorporated automobiles will less likely to cause explosions upon collision with other vehicles so as to provide better road safety.

The entire power system is very flexible in the sense that the rate of water dissociation and the rate of electrical current generation are controlled by the required current output by the fusion electricity generating device, such that no excess electrical current or excess oxygen or hydrogen gas is formed to enhance the safety of the power system.

Furthermore, drivers of automobiles no longer need to worry about running low on fuels and have to tolerate the hassle of looking for gas station. This power system is especially useful for water vehicles such as boats, ships or submarines, since conventional boats and submarines will get stuck in the middle of the ocean due to a running low of fuels and the only thing people on board can do is to wait for help, which may take a long period of time since the location of an object in the ocean is difficult to be accurately determined.

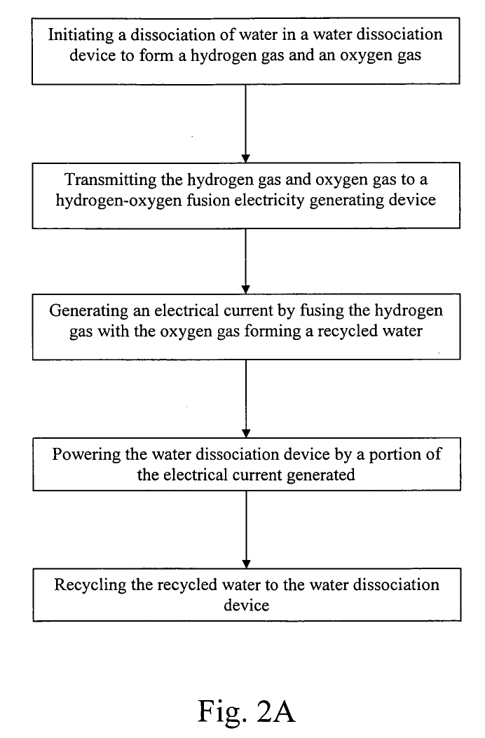

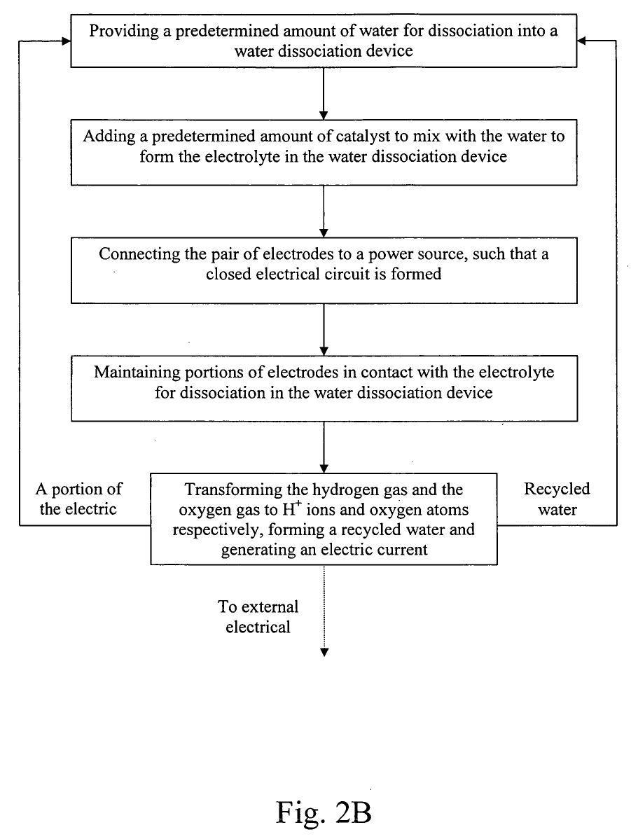

Referring to FIGS. 2A to 2D of the drawings, a method of generating power according to the preferred embodiment of the present invention is illustrated, which comprises the steps of:

(a) initiating a dissociation of water in a water dissociation device 10, 10′ to produce a hydrogen gas and an oxygen gas;

(b) transmitting the hydrogen gas and oxygen gas produced from the water dissociation device 10, 10′ to a fusion electricity generating device 20, i.e. an electric generator; and

(c) generating an electrical current by fusing the hydrogen gas with the oxygen gas forming a recycled water.

The method further comprises the steps of:

(d) powering the water dissociation device 10, 10′ by a portion of the electrical current generated; and

(e) recycling the recycled water to the water dissociation device 10, 10′ as the water for dissociation.

In general, the method of generating power flows in the sequence that hydrogen gas and oxygen gas are formed by dissociating water by conducting an electrical current through water. The hydrogen gas and the oxygen gas will then be guided and transmitted to and fed into the fusion electricity generating device 20 such as a fuel cell system separately, where an electrical current is produced by the fusion action of oxygen gas and hydrogen gas to form a recycled water in the electric generator 20. The recycled water will then be recycled to the water dissociation device 10, 10′ for reusing.

According to FIG. 2B of the drawings, the hydrogen gas and oxygen gas used for generating power by the fusion electricity generating device 20 came from the dissociation of water by an electrolysis process.

The step of dissociating water to form the hydrogen gas and the oxygen gas comprises the substeps of:

(a1) providing a predetermined amount of electrolyte for dissociation in the water dissociation device 10, 10′; and

(a2) maintaining portions of dissociation positive and negative electrodes 15, 15′, 16, 16′ in contact with the electrolyte for dissociation in the water dissociation device 10, 10′, wherein the dissociation positive and negative electrodes 15, 15′, 16, 16′ are spaced apart and electrically connected to a power source 14, 14′ to form a closed electrical circuit.

In the step (a1), the electrolyte contains water, wherein a predetermined amount of dissociation catalyst can be mixed with the water to enhance the efficiency of the water dissociation.

The dissociation positive electrode 15, 15′ is connected to a positive terminal of the power source 14 and the dissociation negative electrode 16, 16′ is connected to a negative terminal of the power source 14.

Theoretically, without the presence of the dissociation catalyst, upon the completion of the electrical circuit, water molecules, H₂O, will undergo an electrolysis process, where the H₂O molecules dissociates to H⁺ ions and OH⁻ ions. However, due to the fact that water molecule is a covalent compound hence the dissociation of water molecule slow, the production of hydrogen gas and oxygen gas is slow, rendering the process not energy efficient.

In order to enhance the production of hydrogen gas and oxygen gas from water, so as to make use of the abundant, environmental friendly substance as an energy source, the process further comprises a step of adding a dissociation catalyst into the water in the water dissociation tank. By adding the dissociation catalyst, the rate of water dissociation is augmented and the dissociation catalyst itself is not being consumed. The dissociation catalyst comprises iodine (I₂) and/or sulfur dioxide (SO₂).

According to this preferred embodiment of the present invention, an electrical circuit with a voltage of 25V and a current of 4 A is sufficient to start up the entire process, such that energy consumption is minimized and energy efficiency of the entire system maximized.

Referring to FIG. 2C of the present invention, the step (c) further comprises the substeps of:

(c1) transforming the hydrogen gas and the oxygen gas to H⁺ ions and oxygen atoms respectively; and

(c2) fusing two H⁺ ions and an oxygen atom to form a recycled water and releasing two electrons to generate the electrical current.

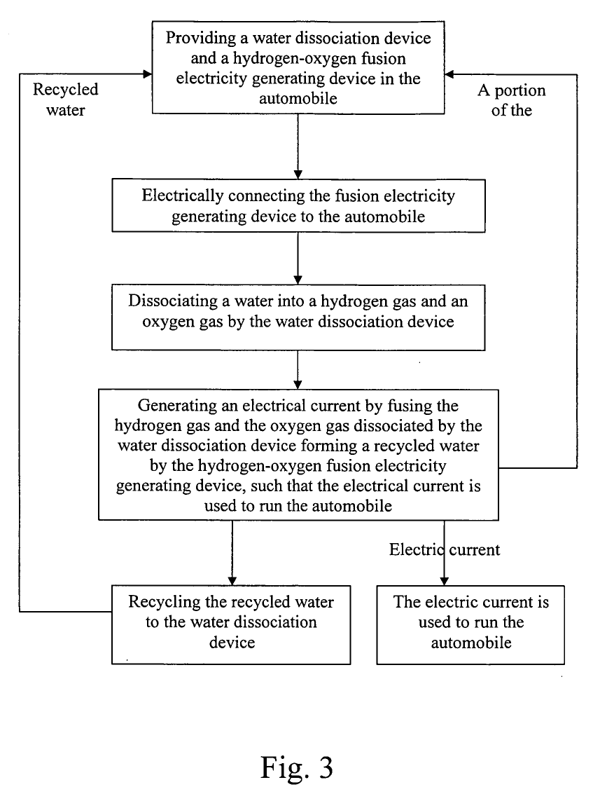

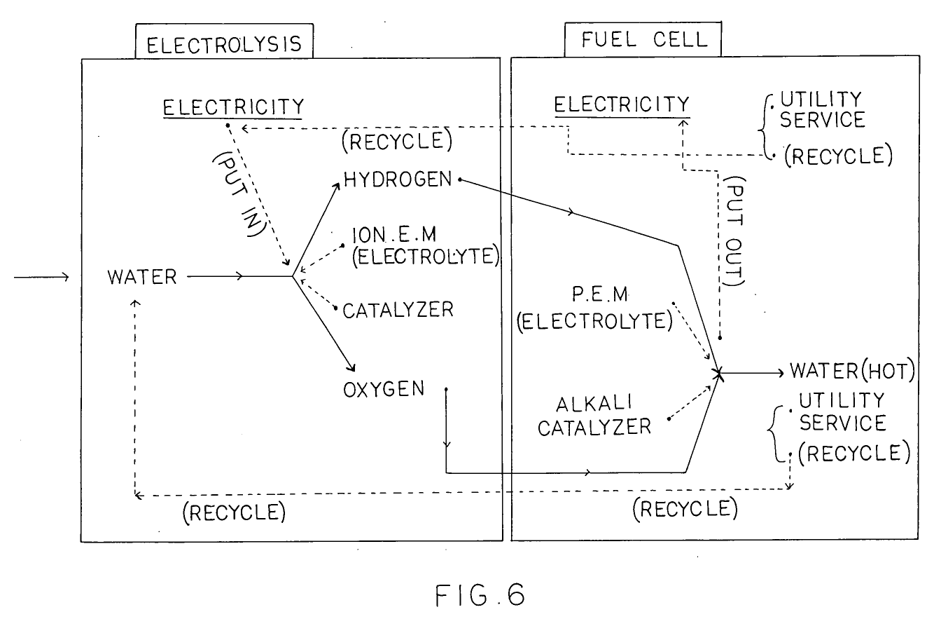

Referring to FIGS. 3 and 6 of the drawings, an alternative embodiment of the present invention provides a method of powering an electric-driven automobile comprising the steps of:

(a) providing a water dissociation device 10, 10′ and a fusion electricity generating device 20, 20′ which is an electric generator in the automobile;

(b) electrically connecting the electric generator 20, 20′ to the automobile;

(c) dissociating a water into a hydrogen gas and an oxygen gas by the water dissociation device 10, 10′; and

(d) generating an electrical current by fusing the hydrogen gas and the oxygen gas dissociated by the water dissociation device 10, 10′ forming a recycled water by the fusion electricity generating device 20, 20′, wherein the electrical current is used to run the automobile.

Furthermore, the method of powering an electric-driven automobile according to the preferred embodiment of the present invention further comprises a step (e) of recycling the recycled water to the water dissociation device 10, 10′.

This method of powering an electric-driven automobile makes use of the fact that water dissociates into hydrogen gas and oxygen gas under electrolysis, whereas the hydrogen gas and the oxygen gas will fuse together to generate an electrical current and water by means of the electric generator, such as the fuel cell system.

The entire method is such that the hydrogen gas and oxygen gas dissociated from water under electrolysis and is used to generate an electrical current to power the automobile. Both the water dissociation device and the fusion electricity generating device are contained in the automobile.

As a result, automobiles neither have to carry around with them a substantial amount of flammable fuels, as do conventional gasoline-powered automobiles, nor a big tank of hydrogen gas for automobiles powered by fuel cells. According to the present invention, the only time when flammable gases exist in this type of electric-driven automobile is when hydrogen gas and oxygen gas are dissociated from water. However, since the gases are used for generating the electrical current almost as soon as they are produced, the actual amount of flammable gases in the automobile is very low, making such automobiles a lot safer than convention gasoline-powered automobiles.

Also, due to the fact that there are no combustion processes inside within them, this type of automobiles will not produce emissions of harmful gases, as oppose to conventional gasoline-powered automobiles. As a result, automobiles will no longer contribute to environmental pollution or global warming, which conventional gasoline-powered automobiles are known to be the greatest cause. The society then will no longer be required to spend zillions of dollars on trying to reverse harmful effects done on the environment by automobiles.

Despite the fact that the water being dissociated into hydrogen gas and oxygen gas in step (c) can come from the recycled water generated in step (e), initially when there is no water inside the water dissociation device, and occasionally when water is lost due to evaporation, water is to be added to the water dissociation device. Hence, the method further comprises a step (f) of adding water to a fluid container of the water dissociation device, wherein step (f) is before step (c).

Also, in order for the water to be dissociated in to hydrogen gas and oxygen gas in a satisfactory rate, the dissociation catalyst can be added. Hence, the method further comprises, before step (c), a step of adding a dissociation catalyst to mix with the water in the water dissociation device.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An inverse-recycle power system, comprising:
a water dissociation device dissociating a water into a hydrogen gas and an oxygen gas, wherein said water dissociation device comprises:
a water inlet,
a water dissociation initializing power source initializing said dissociating of said water,
a dissociation positive electrode and a dissociation negative electrode each having a power connection end electrically connecting to said water dissociation initializing power source,
a contacting portion contacting with said water so as to form an electrical circuit in said water dissociation device,
a hydrogen gas outlet collecting said hydrogen gas produced at said dissociation negative electrode, and
an oxygen gas outlet collecting said oxygen gas produced at said dissociation positive electrode; and
a fusion electricity generating device equipped with said water dissociation device for generating an electrical current through said fusion of said hydrogen gas and said oxygen gas forming a recycled water, wherein said fusion electricity generating device receives said hydrogen gas from said hydrogen gas outlet and said oxygen gas from said oxygen gas outlet of said water dissociation device.

2. The system, as recited in claim 1, wherein a predetermined amount of dissociation catalyst is mixed with the water to form an electrolyte to increase a water dissociation rate.

3. The system, as recited in claim 2, wherein said water dissociation device having a dissociation chamber defined therein to receive said water for dissociation.

4. The system, as recited in claim 2, wherein said dissociation catalyst is selected from a group consisting of iodine and sulfur dioxide.

5. The system, as recited in claim 3, wherein said dissociation catalyst is selected from a group consisting of iodine and sulfur dioxide.

6. The system, as recited in claim 1, wherein said water dissociation device is a solid electrolyte type water dissociation device, wherein an ion exchange membrane is disposed between said dissociation positive electrode and said dissociation negative electrode, wherein said water passes through gaps formed between said dissociation positive and negative electrodes and said ion exchange membrane and is in contact with said dissociation positive and negative electrodes, wherein H⁺ ions are driven to said dissociation negative electrode and OH⁻ ions are driven to said dissociation positive electrode when an electricity passing through said ion exchange membrane between said dissociation positive and negative electrodes, wherein said H⁺ ions receive electrons from said dissociation negative electrode to produce said hydrogen gas at said dissociation negative electrode and said OH⁻ ions releases electrons to said dissociation positive electrode to produce said oxygen gas at said dissociation positive electrode.

7. The system, as recited in claim 2, wherein said water dissociation device is a solid electrolyte type water dissociation device, wherein an ion exchange membrane is disposed between said dissociation positive electrode and said dissociation negative electrode, wherein said water passes through gaps formed between said dissociation positive and negative electrodes and said ion exchange membrane and is in contact with said dissociation positive and negative electrodes, wherein H⁺ ions are driven to said dissociation negative electrode and OH⁻ ions are driven to said dissociation positive electrode when an electricity passing through said ion exchange membrane between said dissociation positive and negative electrodes, wherein said H⁺ ions receive electrons from said dissociation negative electrode to produce said hydrogen gas at said dissociation negative electrode and said OH⁻ ions releases electrons to said dissociation positive electrode to produce said oxygen gas at said dissociation positive electrode.

8. The system, as recited in claim 7, wherein said dissociation catalyst is selected from a group consisting of iodine, sulfur dioxide and potassium hydroxide.

9. The system, as recited in claim 1, wherein said fusion electricity generating device is a fuel cell system.

10. The system, as recited in claim 2, wherein said fusion electricity generating device is a fuel cell system.

11. The system, as recited in claim 4, wherein said fusion electricity generating device is a fuel cell system.

12. The system, as recited in claim 8, wherein said fusion electricity generating device is a fuel cell system.

13. The system, as recited in claim 9, wherein said fuel cell system comprises at least a fuel cell which comprises a proton exchange membrane, a cell positive electrode and a cell negative electrode, wherein said proton exchange membrane is packed between said cell positive and negative electrodes, wherein said cell positive electrode receives said hydrogen gas from said hydrogen gas outlet of said water dissociation device and said cell negative electrode receives said oxygen gas from said oxygen gas outlet of said water dissociation device.

14. The system, as recited in claim 10, wherein said fuel cell system comprises at least a fuel cell which comprises a proton exchange membrane, a cell positive electrode and a cell negative electrode, wherein said proton exchange membrane is packed between said cell positive and negative electrodes, wherein said cell positive electrode receives said hydrogen gas from said hydrogen gas outlet of said water dissociation device and said cell negative electrode receives said oxygen gas from said oxygen gas outlet of said water dissociation device.

15. The system, as recited in claim 11, wherein said fuel cell system comprises at least a fuel cell which comprises a proton exchange membrane, a cell positive electrode and a cell negative electrode, wherein said proton exchange membrane is packed between said cell positive and negative electrodes, wherein said cell positive electrode receives said hydrogen gas from said hydrogen gas outlet of said water dissociation device and said cell negative electrode receives said oxygen gas from said oxygen gas outlet of said water dissociation device.

16. The system, as recited in claim 1, wherein said initializing power source is a capacitor connected to said electric current generated by said fusion electricity generating device such that a portion of said electric current generated is stored in said capacitor to initialize a next water dissociation.

17. The system, as recited in claim 4, wherein said initializing power source is a capacitor connected to said electric current generated by said fusion electricity generating device such that a portion of said electric current generated is stored in said capacitor to initialize a next water dissociation.

18. The system, as recited in claim 8, wherein said initializing power source is a capacitor connected to said electric current generated by said fusion electricity generating device such that a portion of said electric current generated is stored in said capacitor to initialize a next water dissociation.

19. The system, as recited in claim 11, wherein said initializing power source is a capacitor connected to said electric current generated by said fusion electricity generating device such that a portion of said electric current generated is stored in said capacitor to initialize a next water dissociation.

20. The system, as recited in claim 12, wherein said initializing power source is a capacitor connected to said electric current generated by said fusion electricity generating device such that a portion of said electric current generated is stored in said capacitor to initialize a next water dissociation.

21. The system, as recited in claim 19, wherein said capacitor is a lead-acid accumulator.

22. The system, as recited in claim 20, wherein said capacitor is a lead-acid accumulator.

23. The system, as recited in claim 4, wherein a ratio between said water, said iodine and said sulfur dioxide is 2:1:1 by mole.

24. The system, as recited in claim 11, wherein a ratio between said water, said iodine and said sulfur dioxide is 2:1:1 by mole.

25. The system, as recited in claim 1, wherein the initializing power source has a voltage of 25V and a current of 4 A.

26. A method of generating power, comprising the steps of:
(a) initiating a dissociation of a water in a water dissociation device to produce a hydrogen gas and an oxygen gas;
(b) transmitting said hydrogen gas and oxygen gas produced from said water dissociation device to a fusion electricity generating device; and
(c) generating an electrical current by fusing said hydrogen gas with said oxygen gas forming a recycled water.

27. The method, as recited in claim 26, after the step (c), further comprising a step of:
(d) powering said water dissociation device by a portion of said electrical current generated.

28. The method, as recited in claim 27, after the step (d), further comprising a step of:
(e) recycling said recycled water to said water dissociation device.

29. The method, as recited in claim 26, wherein the step (a) comprises the substeps of:
(a1) providing a predetermined amount of said water for dissociation in said water dissociation device; and
(a2) maintaining portions of dissociation positive and negative electrodes in contact with said water for dissociation in said water dissociation device, wherein said dissociation positive and negative electrodes are spaced apart and electrically connected to a power source to form a closed electrical circuit.

30. The method, as recited in claim 29, wherein a predetermined amount of dissociation catalyst is mixed with said water to enhance an efficiency of said dissociating of said water.

31. The method, as recited in claim 30, wherein said dissociation catalyst is selected from a group consisting of iodine and sulphur dioxide.

32. The method, as recited in claim 26, wherein the step (c) comprises the substeps of:
(c1) transforming said hydrogen gas and said oxygen gas to H⁺ ions and oxygen atoms respectively; and
(c2) fusing two said H⁺ ions and one of said oxygen atoms to form said recycled water and releasing two electrons to generate said electrical current.

33. The method, as recited in claim 30, wherein the step (c) comprises the substeps of:
(c1) transforming said hydrogen gas and said oxygen gas to H⁺ ions and oxygen atoms respectively; and
(c2) fusing two said H⁺ ions and one of said oxygen atoms to form said recycled water and releasing two electrons to generate said electrical current.

34. The method, as recited in claim 28, wherein the step (a) comprises the substeps of:
(a1) providing a predetermined amount of said water for dissociation in said water dissociation device;
(a2) maintaining portions of dissociation positive and negative electrodes in contact with said water for dissociation in said water dissociation device, wherein said dissociation positive and negative electrodes are spaced apart and electrically connected to a power source to form a closed electrical circuit.

35. The method, as recited in claim 34, wherein a predetermined amount of dissociation catalyst is mixed with said water to enhance an efficiency of said dissociating of said water.

36. The method, as recited in claim 35, wherein said dissociation catalyst is selected from a group consisting of iodine and sulphur dioxide.

37. The method, as recited in claim 36, wherein said iodine, said sulphur dioxide and said water are in a ratio of 1:1:2 by mole.

38. The method, as recited in claim 36, further comprising a step of recycling a recycled iodine and a recycled sulfur dioxide into said water dissociation device.

39. The method, as recited in claim 28, wherein the step (c) comprises the substeps of:
(c1) transforming said hydrogen gas and said oxygen gas to H⁺ ions and oxygen atoms respectively; and
(c2) fusing two said H⁺ ions and one of said oxygen atoms to form said recycled water and releasing two electrons to generate said electrical current.

40. The method, as recited in claim 33, wherein said step (c) is carried out by a fuel cell system.

41. The method, as recited in claim 39, wherein said step (c) is carried out by a fuel cell system.

42. A method of powering an electrical automobile, comprising the steps of:
(a) providing a water dissociation device and a fusion electricity generating device within said automobile;
(b) electrically connecting said fusion electricity generating device to said automobile;
(c) dissociating a water into a hydrogen gas and an oxygen gas by said water dissociation device; and
(d) generating an electrical current by fusing said hydrogen gas and said oxygen gas dissociated by said water dissociation device to form a recycled water by said fusion electricity generating device, wherein said electrical current is used to run said automobile.

43. The method, as recited in claim 42, wherein the step (c) comprises the substeps of:
(c1) providing a predetermined amount of said water for dissociation in said water dissociation device;
(c2) mixing a predetermined amount of dissociation catalyst with said water to form an electrolyte in said water dissociation device;
(c3) maintaining portions a pair of electrical conductors in contact with said electrolyte in said water dissociation device; and
(c4) forming an electrical circuit by connecting said pair of electrical conductors to a positive electrode and a negative electrode of an initializing power source respectively, wherein said hydrogen gas is produced at said electrical conductor connected to said negative electrode and said oxygen gas is produced at said electrical conductor connected to said positive electrode.

44. The method, as recited in claim 43, wherein said dissociation catalyst is selected from a group consisting of an iodine and a sulfur dioxide.

45. The method, as recited in claim 44, wherein said iodine, said sulfur dioxide and said water are in a ratio of 1:1:2 by mole.

46. The method, as recited in claim 43, after the step (d), further comprising a step of:
(e) recycling said recycled water to said water dissociation device.

47. The method, as recited in claim 44, further comprising a step of recycling a recycled iodine and a recycled sulfur dioxide into said water dissociation device.

48. The method, as recited in claim 43, wherein said step (d) comprises the substeps of:
(d1) transforming said hydrogen gas and said oxygen gas to H⁺ ions and oxygen atoms respectively; and
(d2) fusing two of said H⁺ ions and one of said oxygen atoms to form said recycled water and releasing two electrons to form said electrical current.

49. The method, as recited in claim 48, wherein said step (d) is carried out by a fuel cell system.
